(19) United States
(12) Patent Application Publication
(10) Pub. No.: US 2017/0326427 A1
(43) Pub. Date: Nov. 16, 2017

(54) GOLF SWING TEACHING DEVICE

(71) Applicants: William Smith, Farmington, CT (US); Kelsey Baker, Farmington, CT (US)

(72) Inventors: William Smith, Farmington, CT (US); Kelsey Baker, Farmington, CT (US)

(21) Appl. No.: 15/230,802

(22) Filed: Aug. 8, 2016

Related U.S. Application Data
(63) Continuation of application No. 14/791,965, filed on Jul. 6, 2015, now abandoned.

(51) Int. Cl. A63B 69/36; A63B 71/06; A63B 57/10; G09B 19/00; A63B 24/00; A63B 102/32

(52) U.S. Cl. CPC A63B 69/3661; G09B 19/0038; A63B 71/0686; A63B 57/10; A63B 24/0006; A63B 69/36; A63B 71/0622; A63B 2102/32; A63B 2024/0015; A63B 2071/0625; A63B 2207/02

(57) ABSTRACT

A golf swing teaching device to interpret a golf swing comprising a golf club, where the golf club includes a handle, a shaft and a head; a laser attached to the golf club, where the laser directs a beam parallel to the shaft of the golf club; a reflective indicator mat, where the reflective indicator mat extends between a first end and a second end; a rest toward the first end, where the rest positions a golf ball on the reflective indicator mat; an ideal swing line along a central portion of the reflective indicator mat, where the ideal swing line extends from the first end to the second end; and a plurality of sensors along the reflective indicator mat, where the plurality of sensors detect a path of the beam over the reflective indicator mat and deviation of the beam from the ideal swing line.

### CROSS REFERENCE TO OTHER APPLICATIONS

This application is a continuation of U.S. application Ser. No. 14/791,965 filed on Jul. 6, 2015.

### BACKGROUND OF THE INVENTION

### Field of the Invention

The present invention relates to a golf teaching device that assists a user to correct swing errors by notifying them immediately as to the direction of their swing.

### Description of Related Art

Golf is a sport enjoyed by a wide range of individuals the world over. Many people like to golf for the leisurely experience of being outside and socializing with others. Others thrive from the competitive side of the sport constantly trying to improve and even winning money and prizes at tournaments. While the reasons to play may differ, a few pieces of equipment are standard to each golfer. For example, each person needs a set of clubs and a ball. The type of clubs varies for each user depending on the length of the shaft, size and weight of the head etc. Each golfer has their favorite equipment specifically chosen and fitted to them.

Amateur and professional golfers alike are continuously trying to improve their skill in the game. Some people may choose to take lessons from professionals where analysis of their swing, stance and putt is interpreted and tips are offered for improvement. The teacher repeatedly observes the student, so that the skill is learned and mistakes are corrected. Alternatively, others may seek to practice and train alone employing swing perfecting aids and equipment to electronically interpret their swing. While these devices are helpful they typically only analyze one aspect of the swing or provide information for just a few swing types. Also, these devices do not offer ways to correct the swing as a teacher would, so the user must learn how to correct themselves with only minimal input. Over time these aids are often found to be obsolete after the swing is perfected leaving the golfer with a mass of equipment they must store or sell.

Therefore it would be beneficial in the art to provide a golfer with a device that interprets the various stages of their swing and offers ways to correct any deviation from ideal. Also it would be desirable in the art to provide a device that is able to interpret a variety of different swing styles so that the device does not become obsolete after mastery of a single swing style.

### SUMMARY OF THE INVENTION

In view of the foregoing disadvantages inherent in the prior art, the general purpose of the present invention is to provide a golf swing teaching device to interpret a golf swing, configured to include all of the advantages of the prior art, and to overcome the drawbacks inherent therein.

Accordingly, an object of the present invention is to provide a golf swing teaching device that includes a laser attached to a shaft of a golf club, where the laser directs a beam parallel to the shaft. The device includes an indicator mat with a plurality of sensors, where the laser beam triggers the sensors as the golf club passes over the mat.

Another object of the present invention is to provide a golf swing teaching device with a microprocessor within the indicator mat, where the microprocessor analyzes the path of the laser beam over the mat to provide how the path deviates from the ideal path. The microprocessor further offers corrections to improve the user's swing.

To achieve the above objects, in an aspect of the present invention, a golf swing teaching device is described comprising a golf club, where the golf club includes a handle, a shaft and a head; a laser attached to the golf club, where the laser directs a beam parallel to the shaft of the golf club; a reflective indicator mat, where the reflective indicator mat extends between a first end and a second end; a rest toward the first end, where the rest positions a golf ball on the reflective indicator mat; an ideal swing line along a central portion of the reflective indicator mat, where the ideal swing line extends from the first end to the second end; and a plurality of sensors along the reflective indicator mat, where the plurality of sensors detect a path of the beam over the reflective indicator mat and deviation of the beam from the ideal swing line.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a golf swing teaching device in accordance with an exemplary embodiment of the present invention; and

FIG. 2 depicts a top view of an indicator mat in accordance with an exemplary embodiment of the present invention.

FIG. 3 depicts a top view of an alternative embodiment of an indicator mat in accordance with an exemplary embodiment of the present invention.

Like reference numerals refer to like parts throughout the description of several views of the drawings.

### DETAILED DESCRIPTION OF THE DRAWINGS

The present invention relates to a golf teaching device that assists a user to correct swing errors by notifying them immediately as to the direction of their swing. The present invention provides a golf swing teaching device to provide golfers with a tool that facilitates improving and perfecting various swings. The golf swing teaching device includes an electronic mat with various sensors along the length. A laser is attached to a golf club, where the laser transmits a beam along the shaft towards the head and another beam towards the handle. The user prepares a ball on the mat and then positions themselves with the club and laser. As they perform the swing the laser triggers sensors on the mat to indicate to the user the path that their swing follows. Once specific sensors are triggered, corrections are offered from the mat to improve the swing.

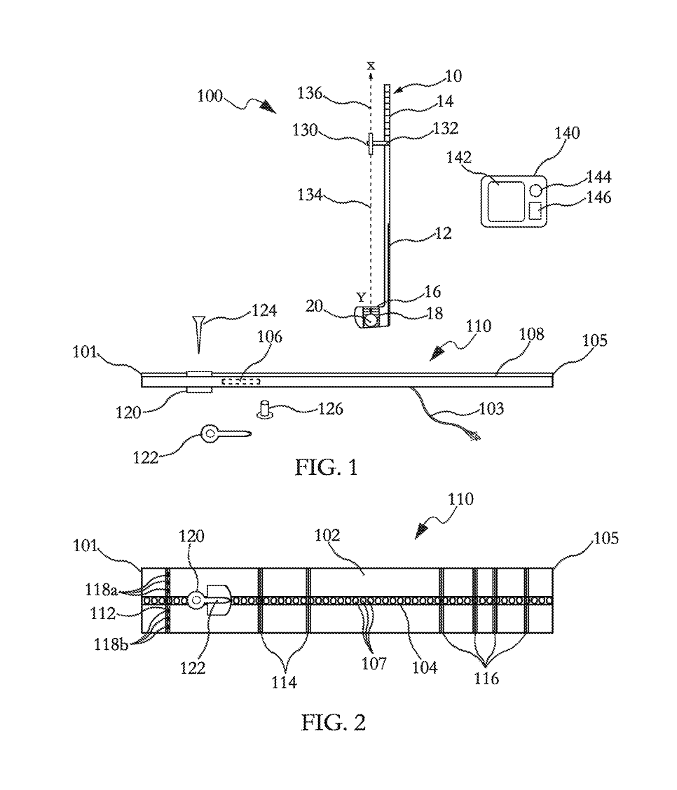

Turning now descriptively to the drawings, referring to FIG. 1, a golf swing teaching device 100 is shown in accordance with an exemplary embodiment of the present invention. The golf swing teaching device 100 includes an indicator mat 110 that rests on the floor or ground. The indicator mat 110 extends between a first end 101 and a second end 105. The indicator mat 110 is electronic, and may be rechargeable by plugging a cord 103 into a wall outlet. For backup power, the indicator mat 110 may include an internal battery compartment 106. The battery compartment 106 houses batteries to power various electrical components associated with the indicator mat 110. The indicator mat 110 may be made from vinyl or rubber so that it is flexible and may be rolled for storage. The indicator mat 110 includes a top surface 102. The top surface 102 may be covered a reflective coat or layer. An artificial turf, like AstroTurf®, may be layered on the top surface 102 to replicate playing on grass. The reflective top surface 102 must be visible through the artificial turf to coordinate with the laser 130, as will be discussed below.

Positioned toward the first end 101 may be a rest 120 upon which a user places a golf ball 20. When preparing for a swing, the user may place the golf ball 20 directly on the rest 120. To provide a barrier between the indicator mat 110 and the golf ball 20, a mat protector 122 may be attached over the rest 120. This way the user will not damage the indicator mat 110 during practice. To provide elevation to the golf ball 20 the user may insert a tee 124 or a rubber stand 126 into the rest 120 thereby giving the user realistic options while practicing their swing.

The indicator mat 110 coordinates with a laser 130 that easily attaches to any golf club 10. The golf club 10 includes a shaft 12, handle 14, head 16 and striking portion 18. The laser 130 includes a fastener 132 to receive the shaft 12. The fastener 132 is adjustable and locks in the ideal position below the handle 14 to prevent interference when the user is swinging. The laser 130 directs a pair of beams 134, 136 in two directions; 180° from each other. A first beam 134 points in the direction indicated with the arrow X, and a second beam 136 points in the direction indicated with arrow Y. The beams 134, 136 run parallel to the shaft 12, where the first beam 134 is parallel to the handle 14 and the second beam 136 is parallel to the shaft and points towards the head 16. During use, the second beam 136 coordinates with sensors on the indicator mat 110 and the reflective top surface 102 to inform the user of their swing and how to make improvements. The sensors will be discussed in further detail in reference to FIG. 2.

The golf swing teaching device 100 further includes a display device 140 to inform the user of their swing while using the indicator mat 110. The display device 140 includes a screen 142 to show the user how they are swinging and provide corrections. The display device 140 further includes a speaker 144 through which the display 140 provides audio for the type of swing and corrections. A plurality of control buttons 146 are on the display device 140 to allow the user to navigate the screen 142 and speaker 144. The display device 140 may be attached to the indicator mat 110. Alternatively, the display device 140 may be portable to keep in the user's pocket or nearby while practicing.

The display device 140 may be incorporated with a swing timer that sounds beeps to indicate to the user the timing or tempo of their swing. For example, three beeps sound as the user moves through their swing. The first beep is to inform the user when to begin their swing, the second beep is when the swing should be at the top, and the third beep is when the club strikes the ball. The commonly established ideal swing ratio of backswing time to downswing impact is 3:1 for full swings and 2:1 for short iron swings. The tempo of the beeps may be changed with the control buttons 146 to change the timing as when hitting shorter distances. Further, preprogrammed tempo settings may be programed into the display device 140 allowing the user to select a specific type of swing to practice.

Referring now to FIG. 2, a top view of the indicator mat 110 is shown in accordance with an exemplary embodiment of the present invention. The indicator mat 110 illustrates the rest 120 with the mat protector 122 in place. The top surface 102 of the indicator mat 110 includes an ideal swing line 104. The ideal swing line 104 runs the length of the indicator mat 110 and illustrates the ideal path along which the user should swing the golf club. The ideal swing line 104 may include a series of lights 107, where the lights illuminate as the laser beam passes directly atop the ideal swing ling 104.

Deviation from the ideal swing line 104 is detected with a plurality of sensors 112, 114, 116 along the top surface 102 of the indicator mat 110. A rear sensor 112 is positioned between the first end 101 and the rest 120. The rear sensor 112 provides information about the backswing of the user. A pair of impact sensors 114 near the rest 120, positioned opposite to the rear sensor 112, provides information about how the user strikes the ball. Finally, a set of follow-through sensors 116 are positioned towards the second end 105 provides information about how the user follows through with the swing. The rear sensor 112 and the impact sensors 114 may coordinate with the swing timer within the display device 140. The rear sensor 112 may detect when the swing is initiated and when the club reaches the top of the swing. The impact sensor 112 detects when the ball is hit. This way the user's swing time is analyzed compared to the ideal swing tempos of either 3:1 or 2:1, thereby improving the swing. As mentioned above, the tempo may be changed within the display device adjusting for various distances desired to be hit.

The sensors 112, 114, 116 may be lit with different lights on each side of the ideal swing line 104. FIG. 2 illustrates the rear sensor 112 with lights 118a, 118b, where the lights 118a, 118b illuminate independently from each other depending on how the laser beam passes over the sensor 112. All of the sensors 112, 114, 116 may include the lights 118a, 118b, so as the laser beam passes over the sensors 112, 114, 116, the specific side of the ideal swing line 104 illuminates to indicate to the user the path of their swing.

During use, the laser attached to the golf club points towards the indicator mat. The path the laser beam passes over the indicator mat provides information about the user's swing. The indicator mat includes a microprocessor to communicate to the display device how the path of the laser over the indicator mat relates to the errors in the swing. Further, the microprocessor calculates how the user can improve or make corrections before their next swing. For example, if the laser passes over the sensors near the rest, either above or below the ideal swing ling, the user may be bending their wrist too much when they strike the ball. The display device will inform the user as to this error and then suggest that the user straighten their wrist. The user is able to immediately correct their mistake and practice improvements on their following swings. With the golf swing teaching device the user is provided an innovative product which helps golfers, both amateur and professional, improve a number of swing varieties. The immediate responsiveness allows the user to know what they are doing wrong and how to correct it, so that they stop repeatedly performing the same mistakes. As the user improves, less and less deviation from the ideal swing line may be detected thus improving their overall golf game.

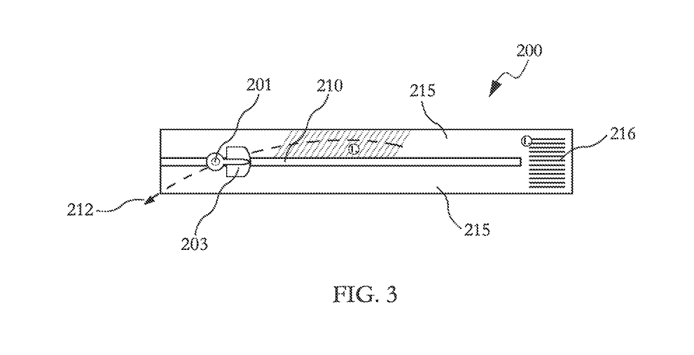

As an alternative embodiment, shown in FIG. 3, an indicator mat 200 may include markings that reflect the swing of the user, where laser 130 is directed over a top surface 215. The top surface 215 may include a reflective coating that shows the passing of the laser 130 as a user swings the club over the top surface 215. Such a tracking 212 is shown in FIG. 3. The tracking 212 is shown for exemplary purposes and gives an indication of a swing path of a user. The top surface 215 includes a center marking 210 that indicates a perfect swing path. Ideally the user attempts to keeps their swing within this center marking 210. A target 201 is provided at one end of the center marking 210 to indicate ball placement. As the user takes their swing, laser 130 projects onto top surface 215 thus giving the user an instantaneous indication of a swing direction. The laser 130 as shown in FIG. 1 directs beams in two directions therefore the beam 136 may provide an indication of the position of the back swing on the top surface 215 and the back swing alignment with the target 201. As the swing follows through the beam 134 is directed onto the mat 110 providing an indication of the travel of the swing over the mat. The top surface 215 has markings indicating the quality of the swing as it takes place. Color coding may be provided with the top surface 215 to graphically indicate the swing engaged by the user. Such markings may include the center marking 210 directed to the target providing an ideal swing travel. Therefore, a suitable swing follows an ideal path along the center marking 210 with target alignment, target 201, clearly marked on the top surface 215. Further markings on the top surface 102 may include markings to indicate incorrect swing paths, however the laser's path is clearly seen over the top surface 215. The tracking 212 shows a swing path through a representative marking on the mat 110 indicating a an “over the top swing” flaw. Further, the mat 110 includes a listing 216 of the most likely causes and resulting errant ball flights of each swing path flaw. As the such the user receives instantaneous feedback of the takeaway, backswing, transition, downswing and impact.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A golf swing teaching device to interpret a golf swing comprising:
a. a golf club, where the golf club includes a handle, a shaft and a head;
b. a laser attached to the golf club, where the laser directs a beam parallel to the shaft of the golf club;
c. a reflective indicator mat, where the reflective indicator mat extends between a first end and a second end;
d. a rest toward the first end, where the rest positions a golf ball on the reflective indicator mat;
e. an ideal swing line along a central portion of the reflective indicator mat, where the ideal swing line extends from the first end to the second end; and
f. a plurality of sensors along the reflective indicator mat, where the plurality of sensors detect a path of the beam over the reflective indicator mat and deviation of the beam from the ideal swing line.

2. The golf swing teaching device according to claim 1, where the reflective indicator mat includes a microprocessor, where the microprocessor interprets the path the beam follows over the reflective indicator mat.

3. The golf swing teaching device according to claim 1, further including a display device, where the display device communicates deviation of the golf swing from the ideal swing line and provides corrections.

4. The golf swing teaching device according to claim 3, where the display device includes a screen, a speaker and a plurality of control buttons.

5. The golf swing teaching device according to claim 4, where the display device further includes a swing timer, where the swing timer creates a series of preprogrammed sounds to indicate a tempo of a swing.

6. The golf swing teaching device according to claim 5, where the tempo is controlled by the plurality of control buttons.

7. The golf swing teaching device according to claim 3, where the display device attaches to the reflective indicator mat.

8. The golf swing teaching device according to claim 3, where the display device is portable.

9. The golf swing teaching device according to claim 1, where the plurality of sensors include a series of lights on each side of the ideal swing line,

10. The golf swing teaching device according to claim 9, where the series of lights are independent to each other on each side of the ideal swing line.

11. The golf swing teaching device according to claim 1, where the plurality of sensors includes a rear sensor, at least one impact sensor and at least one follow-through sensor.

12. The golf swing teaching device according to claim 1, where the rest includes a mat protector, where the mat protector provides a barrier between the head of the golf club and the reflective indicator mat.

13. The golf swing teaching device according to claim 1, where the rest receives one of at least a tee or a stand to elevate the golf ball.

14. The golf swing teaching device according to claim 1, where the reflective indicator mat is covered with an artificial turf.

15. The golf swing teaching device according to claim 1, where the reflective indicator mat includes a battery pack.

16. The golf swing teaching device according to claim 1, where the reflective indicator mat is rechargeable.

17. A golf swing teaching device to interpret a golf swing comprising:
a. a golf club, where the golf club includes a handle, a shaft and a head;
b. a laser attached to the golf club, where the laser directs a beam parallel to the shaft of the golf club;
c. a indicator mat, where the indicator mat extends between a first end and a second end;
d. a rest toward the first end, where the rest positions a golf ball as a target on the indicator mat;
e. an ideal swing line along a central portion of the reflective indicator mat, where the ideal swing line extends from the first end to the second end; and
f. a color indication display over a top surface of the indicator mat, where the color indication display provides immediate feedback regarding a user's swing.

18. The golf swing teaching device to interpret a golf swing according to claim 17, where the color indication display includes a centerline indicating an ideal swing, down swing indicators and back swing indicator.
